(19) United States
(12) Patent Application Publication
(10) Pub. No.: US 2019/0259044 A1
(43) Pub. Date: Aug. 22, 2019

(54) SYSTEM FOR DETERMINING VEHICLE USE STATISTICS AND METHOD THEREOF

(71) Applicant: HONDA MOTOR CO., LTD., Tokyo (JP)

(72) Inventor: Kiyotaka Kawashima, Los Angeles, CA (US)

(21) Appl. No.: 15/900,332

(22) Filed: Feb. 20, 2018

(51) Int. Cl. G06Q 30/02; G07C 5/08

(52) U.S. Cl. CPC G06Q 30/0202; G01G 19/08; G06Q 30/0201; G07C 5/085

(57) ABSTRACT

Vehicle use statistics can be determined, during a driving operation of a vehicle and based at least in part on one or more sensors in the vehicle, by determining a number of passengers in the vehicle, determining, based at least in part on the one or more sensors in the vehicle and where the number of passengers in the vehicle is at least one, a level of intimacy between a driver of the vehicle and at least one of the number of passengers in the vehicle, and determining, based at least in part on the number of passengers in the vehicle or the level of intimacy, a purpose associated with the driving operation. An indication of the purpose associated with the driving operation can be stored and/or used to predict future vehicle manufacturing needs.

### BACKGROUND

The automotive industry is one of the largest in the nation and around the world, as many households have one or more automobiles, businesses have multiple, and even fleets of, automobiles, etc. In this regard, in-depth market analysis is performed to determine and predict trends for manufacturing certain types of vehicles and improve available vehicle options to improve consumer experience and automobile selection. Such analysis typically includes consumer surveys, which require time and cooperation to complete the surveys. Further, the received information may not be accurate or complete. There is a need in the art, therefore, for obtaining in-depth accurate and complete vehicle market analysis data, without the need for time-consuming surveys or cooperation from consumers.

### SUMMARY

The following presents a summary of one or more aspects of the disclosure in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects of the disclosure in a simplified form as a prelude to the more detailed description that is presented later.

In an example, a method of determining vehicle use statistics is provided. The method includes determining, during and after a driving operation of a vehicle and based at least in part on one or more sensors in the vehicle, a number of passengers in the vehicle, determining, based at least in part on the one or more sensors in the vehicle and where the number of passengers in the vehicle is at least one, a level of intimacy between a driver of the vehicle and at least one of the number of passengers in the vehicle, determining, based at least in part on the number of passengers in the vehicle or the level of intimacy, a purpose associated with the driving operation, and storing an indication of the purpose associated with the driving operation.

In another example, a vehicle is provided that includes a vehicle statistics system, which can include one or more sensors for detecting presence of one or more passengers in the vehicle, a memory, and at least one processor coupled to the memory. The at least one processor is configured to determine, during and after a driving operation of the vehicle and based at least in part on the one or more sensors in the vehicle, a number of passengers in the vehicle, determine, based at least in part on the one or more sensors in the vehicle and where the number of passengers in the vehicle is at least one, a level of intimacy between a driver of the vehicle and at least one of the number of passengers in the vehicle, determine, based at least in part on the number of passengers in the vehicle or the level of intimacy, a purpose associated with the driving operation, and store an indication of the purpose associated with the driving operation.

In a further example, a non-transitory computer-readable medium storing computer executable code for determining vehicle use statistics is provided. The code includes code for determining, during and after a driving operation of a vehicle and based at least in part on one or more sensors in the vehicle, a number of passengers in the vehicle, determining, based at least in part on the one or more sensors in the vehicle and where the number of passengers in the vehicle is at least one, a level of intimacy between a driver of the vehicle and at least one of the number of passengers in the vehicle, determining, based at least in part on the number of passengers in the vehicle or the level of intimacy, a purpose associated with the driving operation, and storing an indication of the purpose associated with the driving operation.

To the accomplishment of the foregoing and related ends, the one or more aspects of the disclosure comprise the features hereinafter fully described and particularly pointed out in the claims. The following description and the annexed drawings set forth in detail certain illustrative features of the one or more aspects. These features are indicative, however, of but a few of the various ways in which the principles of various aspects can be employed, and this description is intended to include all such aspects and their equivalents.

### BRIEF DESCRIPTION OF THE DRAWINGS

The novel features believed to be characteristic of aspects described herein are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 illustrates a schematic view of an example operating environment of a vehicle statistics system according to one aspect of the disclosure;

FIG. 2 illustrates a schematic view of an example operating environment of a remote server according to one aspect of the disclosure;

FIG. 3 illustrates a flowchart showing an example method for determining driving operation purposes according to one aspect of the disclosure;

FIG. 4 illustrates a flowchart showing an example method for determining a travel pattern according to one aspect of the disclosure;

FIG. 5 illustrates a flowchart showing an example method for predicting vehicle manufacturing needs according to one aspect of the disclosure;

FIG. 6 illustrates a visual example of a driving operation and corresponding purposes associated therewith according to one aspect of the disclosure;

FIG. 7 presents an example system diagram of various hardware components and other features according to one aspect of the disclosure; and

FIG. 8 is a block diagram of various example system components according to one aspect of the disclosure.

### DETAILED DESCRIPTION

The following includes definitions of selected terms employed herein. The definitions include various examples and/or forms of components that fall within the scope of a term and that can be used for implementation. The examples are not intended to be limiting.

The term “bus,” as used herein, can refer to an interconnected architecture that is operably connected to transfer data between computer components within a singular or multiple systems. The bus can be a memory bus, a memory controller, a peripheral bus, an external bus, a crossbar switch, and/or a local bus, among others. The bus can also be a vehicle bus that interconnects components inside a vehicle using protocols such as Controller Area network (CAN), Local Interconnect Network (LIN), among others.

The term “driving operation,” as used herein, can refer to operating a vehicle for a period of time, which may be defined by a period of detected vehicle movement without stopping for at least a threshold period of idle time, a period of time between a detected starting or stopping of the vehicle (e.g., starting or stopping of the ignition or other control systems), a period of time between plugging-in an electronic vehicle, a combination thereof, and/or the like.

The term “memory,” as used herein, can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

The term “operable connection,” as used herein, can include a connection by which entities are “operably connected”, is one in which signals, physical communications, and/or logical communications can be sent and/or received. An operable connection can include a physical interface, a data interface and/or an electrical interface.

The term “processor,” as used herein, can refer to a device that processes signals and performs general computing and arithmetic functions. Signals processed by the processor can include digital signals, data signals, computer instructions, processor instructions, messages, a bit, a bit stream, or other computing that can be received, transmitted and/or detected. A processor, for example, can include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described herein.

The term “telematics system,” as used herein, can refer to a system that facilitates intercommunication among vehicle systems, communication with the vehicle systems via one or more other systems or devices, etc. In an example, telematics systems can interface with other systems, such as a remote device, other computers, etc., via a wireless communication technology, such as a cellular technology, Bluetooth, etc. using a corresponding modem or transceiver.

The term “vehicle,” as used herein, can refer to any moving vehicle that is capable of carrying one or more human occupants and is powered by any form of energy. The term “vehicle” can include, but is not limited to: cars, trucks, vans, minivans, SUVs, motorcycles, scooters, boats, personal watercraft, and aircraft. In some cases, a motor vehicle includes one or more engines.

The term “vehicle operator,” as used herein, can refer to an entity (e.g., a person or other being, robot or other mobile unit, etc.) that can operate a vehicle. The vehicle operator can carry a remote device or other mechanism for activating one or more vehicle systems or other components of the vehicle.

The term “vehicle system,” as used herein, can refer to an electronically controlled system on a vehicle operable to perform certain actions on components of the vehicle, which can provide an interface to allow operation by another system or graphical user interaction. The vehicle systems can include, but are not limited to, vehicle ignition systems, vehicle conditioning systems (e.g., systems that operate a windshield wiper motor, a windshield washer fluid motor or pump, a defroster motor, heating, ventilating, and air conditioning (HVAC) controls, etc.), vehicle audio systems, vehicle security systems, vehicle video systems, vehicle infotainment systems, vehicle telephone systems, and the like.

The detailed description set forth below in connection with the appended drawings is intended as a description of various configurations and is not intended to represent the only configurations in which the concepts described herein can be practiced. The detailed description includes specific details for the purpose of providing a thorough understanding of various concepts. However, it will be apparent to those skilled in the art that these concepts can be practiced without these specific details. In some instances, well known structures and components are shown in block diagram form in order to avoid obscuring such concepts.

Several aspects of certain systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements can be implemented using electronic hardware, computer software, or any combination thereof. Whether such elements are implemented as hardware or software depends upon the particular application and design constraints imposed on the overall system.

By way of example, an element, or any portion of an element, or any combination of elements can be implemented with a “processing system” that includes one or more processors. One or more processors in the processing system can execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described can be implemented in hardware, software, firmware, or any combination thereof. If implemented in software, the functions can be stored on or encoded as one or more instructions or code on a computer-readable medium. Computer-readable media includes computer storage media. Storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

Various examples described herein relate to combining vehicle telematics data and vehicle local data to determine how vehicles are being used by drivers for each driving operations. For example, vehicle use statistics can be determined based on input from one or more vehicle sensors, where the statistics can be used to predict future manufacturing need of certain types of vehicles, vehicle options, etc. For example, for a given driving operation of a vehicle, a purpose of the driving operation can be determined and stored, and then analyzed with other purposes of other driving operations for the vehicle and/or multiple vehicles to determine and/or predict trends in future need for certain types of vehicles, vehicle options, etc. For example, the purpose of the driving operation can be determined based on various inputs from the one or more vehicle sensors or otherwise determined parameters. The one or more vehicle sensors may include a seat sensor to detect seat occupancy during a driving operation, a voice recognition system to determine a level of intimacy between the vehicle operator and one or more passengers, a position determining system (e.g., global positioning system (GPS) to determine a location of the vehicle during the driving operation, etc. For example, a purpose of the driving operation can include “commute,” “shopping,” “pick up/drop off” of a known or unknown person, “leisure,” etc., and can be determined based on determining the number of passengers, level of intimacy with the passengers, GPS location(s), period of time (e.g., time-of-day, day-of-week, day-of-month, etc.), and/or the like.

In this regard, for example, the determined purposes for driving operations can provide feedback typically associated with consumer surveys to allow for accumulating vehicle use statistics. This can be used in conjunction with, or alternatively to, consumer survey data or other data to determine future manufacturing need for vehicle, vehicle options, etc. Moreover, for example, today automobiles may be built around satisfying consumer desires for every possible driving operation that may be performed by the driver, whereas consumers may begin using different vehicles (whether owned or rented) for different purposes, such as a driving service for certain driving operations, as ride sharing and vehicle rentals become increasingly popular.

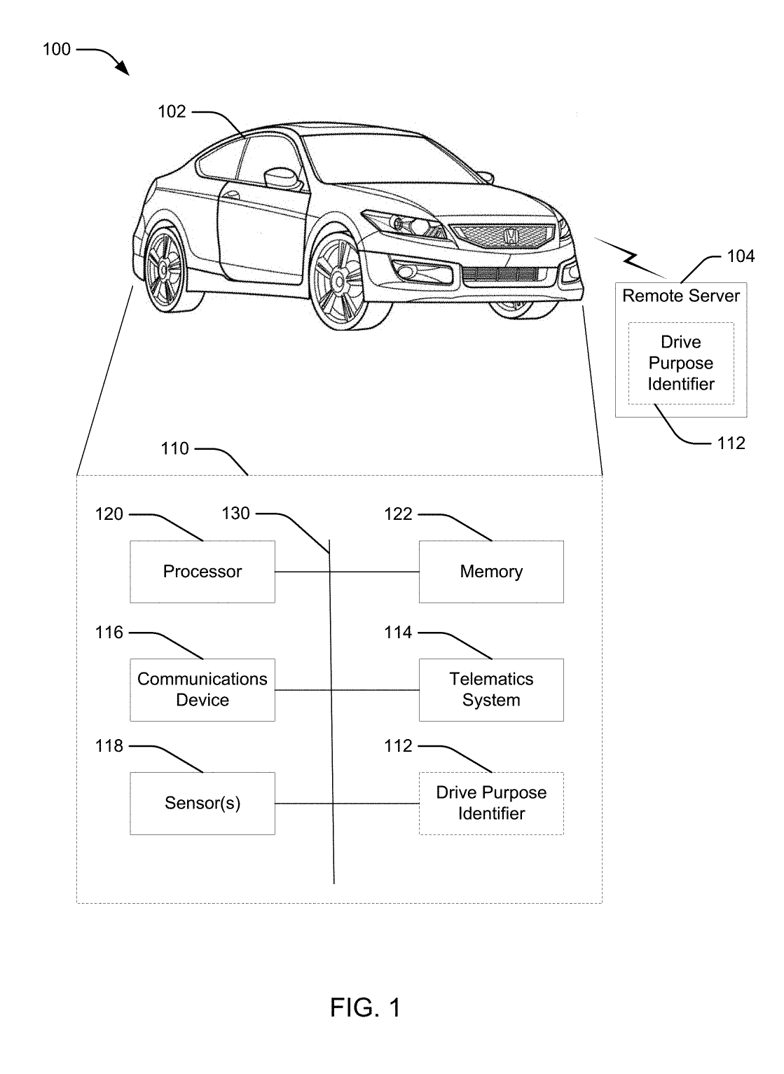

FIG. 1 shows a schematic view of an example operating environment 100 of a vehicle statistics system 110 and example methods according to aspects described herein. For example, operating environment 100 can include a vehicle 102 within which the vehicle statistics system 110 can reside. Operating environment 100 can also include a remote server 104 that can communicate with the vehicle 102 to receive data therefrom, among other possible functions. Components of the vehicle statistics system 110, as well as the components of other systems, hardware architectures and software architectures discussed herein, can be combined, omitted or organized into different architectures for various aspects of the disclosure. However, the example aspects and configurations discussed herein focus on the operating environment 100 as illustrated in FIG. 1, with corresponding system components and related methods.

As shown in FIG. 1, a vehicle statistics system 110 can optionally include a drive purpose identifier 112 for identifying a purpose of one or more driving operations conducted on the vehicle 102. As described herein, the purpose of the driving operation can be stored and used with other similarly identified purposes of driving operations in analyzing how the vehicle 102 is used over a period of time. In another example, as described further herein, the remote server 104 can include the drive purpose identifier 112, which can determine a purpose of one or more driving operations based on data received from the vehicle 102. For example, the drive purpose identifier 112, whether provided in the vehicle statistics system 110 in the vehicle 102 or on a remote server 104, can determine the purpose of one or more driving operations based on similar data received from the vehicle 102.

The vehicle statistics system 110 can also include or can be operably coupled with a telematics system 114 to allow external access to interfaces provided by an electronics control unit (ECU) for communicating with one or more vehicle systems to receive information such as speed, acceleration, braking power, steering yaw, HVAC settings, windshield wiper speed, or substantially information from substantially any vehicle system that is electronically controlled and/or coupled with the telematics system (e.g., via an ECU). In addition, in an example, telematics system 114 may also allow for communicating with one or more sensors 118 in the vehicle to obtain data therefrom, which may include one or more cameras positioned within or outside of the vehicle 102, which may detect occupants of the vehicle, one or more weight sensors (e.g., positioned on one or more seats of the vehicle 102), one or more audio recording systems to capture voice interactions, etc.

Vehicle statistics system 110 can also include one or more communications devices 116 that can transmit and receive wireless signals to a remote server 104 using an electronic communication technology, such as a cellular or other wireless technology (e.g., a third generation partnership project (3GPP) cellular technology, local area network (LAN) technology, Bluetooth®, etc.). In one example, the telematics system 114 can act as a gateway between the remote server 104 and one or more vehicle systems to allow the remote server 104 to receive data from the one or more vehicle systems, and/or the like. In addition, communications to/from the telematics system 114 can be secured using one or more security protocols, such an encryption/decryption mechanism (e.g., public/private key pair), credential authentication, etc.

The vehicle statistics system 110 can also include or be operably coupled with (or executed by) one or more processors 120 and one or more memories 122 that communicate to effectuate certain actions at the vehicle 102 (e.g., actions on or associated with drive purpose identifier 112, telematics system 114, communications device(s) 116, sensors 118, and/or other components described herein). In one example, one or more of the drive purpose identifier 112, telematics system 114, communications device(s) 116, sensor(s) 118, processor(s) 120 and/or memory(ies) 122 can be connected via one or more buses 130. Moreover, in one example, vehicle systems communicatively coupled to the telematics system 114 can include a processor and/or memory, and/or can be operated by processor 120 and/or can utilize memory 122 to effectuate certain actions on the vehicle 102 (e.g., operation of motors, pumps, locks, or other mechanical, electro-mechanical, or electronic devices of the vehicle 102, etc.).

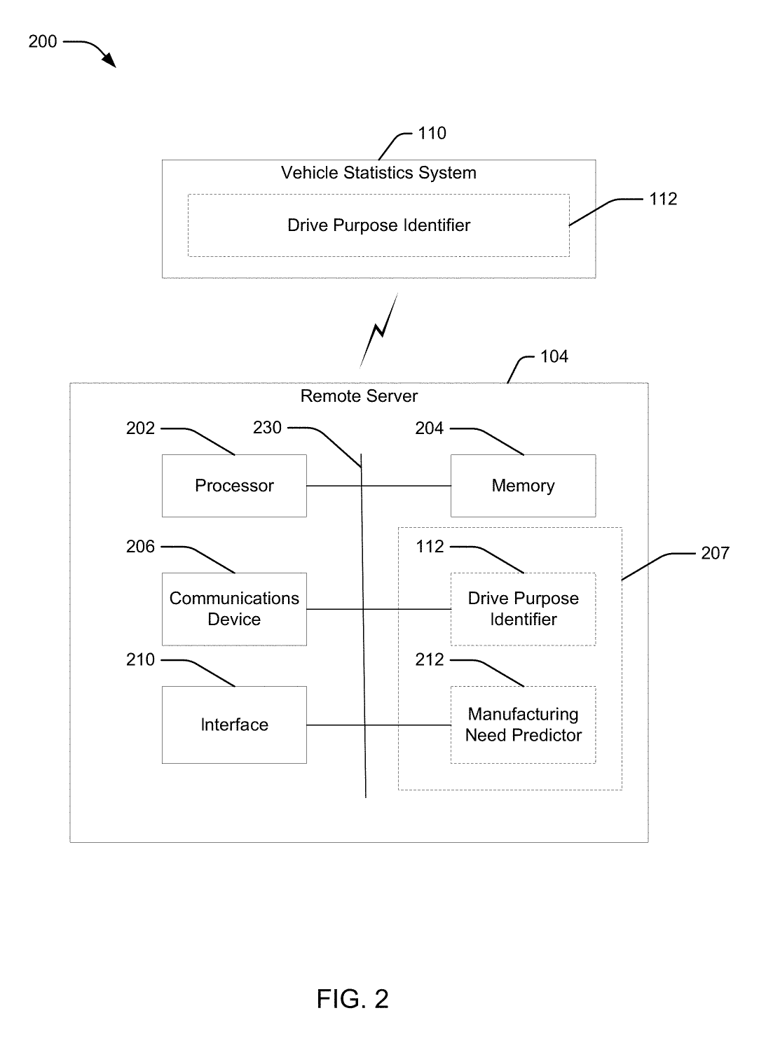

FIG. 2 shows a schematic view of an example operating environment 200 of a vehicle statistics system 110 and remote server 104, and example methods according to aspects described herein. For example, operating environment 200 can include a vehicle statistics system 110, which optionally includes a drive purpose identifier 112, as similarly described above in reference to FIG. 1. Operating environment 200 can also include a remote server 104 that can communicate with the vehicle statistics system 110, and may additionally or alternatively optionally include the drive purpose identifier 112. Components of the remote server 104 shown and described herein, as well as the components of other systems, hardware architectures and software architectures discussed herein, can be combined, omitted or organized into different architectures for various aspects of the disclosure. However, the example aspects and configurations discussed herein focus on the operating environment 200 as illustrated in FIG. 2, with corresponding system components and related methods.

As shown in FIG. 2, remote server 104 can include or be operably coupled with (or executed by) one or more processors 202 and one or more memories 204, which can be similar to processor 120 and/or memory 122 described above. The one or more processors 202 and/or memories 204 can be used to execute, store instructions, and/or store related parameters for one or more additional components of the remote server 104. For example, remote server 104 can also include a communications device 206 for communicating with the vehicle statistics system 110 (or other components of the vehicle 102 in FIG. 1) and/or other devices or systems via one or more wireless communication technologies (e.g., a cellular technology, LAN technology, short-range communication technology, etc.), as described, an interface 210 for providing output and/or accepting input related to one or more applications executed by processor 202 (e.g., a touch screen interface, keyboard, mouse, display, etc.), and an optional manufacturing need predictor 212 for predicting manufacturing needs or trends based on determined driving operation purposes identified for multiple driving operations of multiple vehicle by drive purpose identifier 112. In one example, drive purpose identifier 112 and manufacturing need predictor 212 can be part of an application 207 for receiving or determining driving operation purposes for multiple driver operations, and/or predicting a manufacturing need for certain types of vehicle, vehicle options, etc. based on the driving operation purposes, as described herein. In one example, one or more of the processor(s) 202, memory(ies) 204, communications device 206, interface 210, drive purpose identifier 112, and/or manufacturing need predictor 212 can be connected via one or more buses 230, and/or can include one or more dedicated processors and/or memories, etc. Moreover, in an example, interface 210 can be or include a remotely located interface on a device communicating with remote server 104, such as an external display and a smart watch, among other devices.

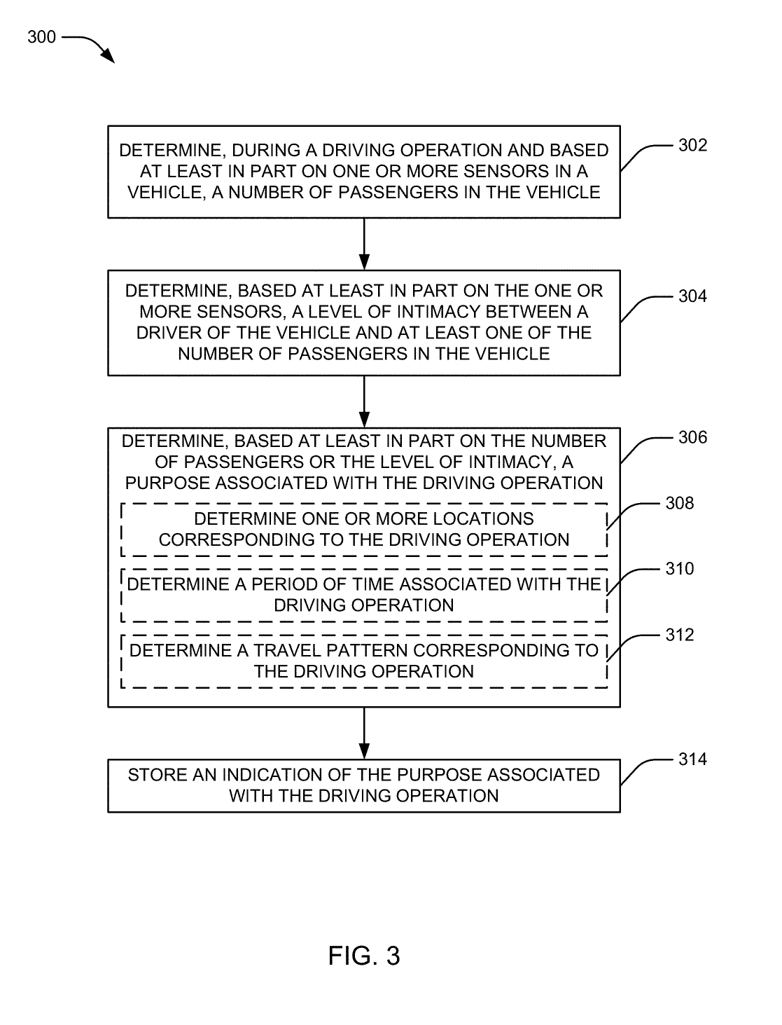

Referring now to FIG. 3, which is described in conjunction with the example operating environment 100 of FIG. 1, an example method 300 for determining a purpose associated with a driving operation is illustrated.

In block 302, the method 300 can include determining, during a driving operation and based at least in part on one or more sensors in a vehicle, a number of passengers in the vehicle. In an aspect, vehicle statistics system 110 (e.g., in conjunction with sensor(s) 118, processor 120 and/or memory 122) can determine, during the driving operation (and/or after the driving operation) and based at least in part on one or more sensors (e.g., sensor(s) 118) in the vehicle (e.g., vehicle 102), a number of passengers in the vehicle. For example, the one or more sensors 118 may include a camera that can detect and/or identify people in the vehicle 102 (e.g., using face outline detection, facial recognition, etc.), and can accordingly detect the number of different people in the vehicle 102 during a specified time interval. In another example, the one or more sensors 118 may include a seat sensor, such as weight sensor on a seat of the vehicle 102 operable to detect weight (e.g., a weight that reaches a threshold) in a given seat of the vehicle 102, an infrared sensor to detect motion or presence of an occupant in the seat of the vehicle 102, etc., and can accordingly infer that the seat is occupied by a passenger. In yet another example, the one or more sensors 118 may include an audio sensor, such as a microphone, configured to detect voice in the vehicle 102, and can accordingly determine the number of passengers in the vehicle 102 based on a number of different voices detected over a period of time.

In one example, drive purpose identifier 112 may detect a change in the number of passengers (e.g., after detecting a stopping of the vehicle, opening/closing of a door via a door sensor, etc., which may occur based on communications from telematics system 114). Based on detecting the change in the number of passengers, for example, drive purpose identifier 112 may also log a location of the vehicle 102 (e.g., via a global positioning system (GPS) sensor, speed and/or direction sensors, etc.) and a timestamp of when the change in number of passengers is detected. Drive purpose identifier 112 can classify this event as a pick-up or drop-off (e.g., based on whether the number of detected passengers increases or decreases, respectively), and can store this information as related to a determined purpose of the driving operation, as described herein. Moreover, in one example, drive purpose identifier 112 can combine pick-up and drop-off data into a single purpose for the driving operation, which may be based at least in part on verifying that the number of pick-ups is equal to (or greater than) the number of drop-offs during the driving operation.

In block 304, the method 300 can include determining, based at least in part on the one or more sensors, a level of intimacy between a driver of the vehicle and at least one of the number of passengers in the vehicle. In an aspect, drive purpose identifier 112 (e.g., in conjunction with vehicle statistics system 110, sensor(s) 118, processor 120 and/or memory 122) can determine, based at least in part on the one or more sensors (e.g., sensor(s) 118), the level of intimacy between the driver of the vehicle and at least one of the number of passengers in the vehicle. For example, drive purpose identifier 112 may be configured to determine the level of intimacy at different possible levels of granularity, such as known or unknown to the driver, relative or friend of the driver (e.g., if known), spouse of the driver, child of the driver, etc. In one example, drive purpose identifier 112 may determine the level of intimacy based on voice recognition of the passenger and known or configured voice profiles associated with the level of intimacy, based on voice recognition to determine words or voice inflection used in communications between the driver and passenger (e.g., informal words or names, lighter inflection, etc., may infer a closer level of intimacy), based on facial recognition of a passenger and known or configured facial profiles associated with the level of intimacy, etc.

Moreover, in an example, a level of intimacy can be inferred additionally or alternatively based on detected passenger location. For example, if passengers are in rear seats without a passenger in the front passenger seat, this may imply a lower level of intimacy between the driver and the passengers than where a passenger is also (or solely) occupying the front passenger seat. In a specific example, a person in front passenger seat may be detected as having a high level of intimacy with the driver, a person in rear seat other than behind the driver seat may be detected as having a medium level of intimacy with the driver, a person in rear seat directly behind the driver seat, or in a third row or further set, may be detected as having a low level of intimacy with the driver, etc. In one example, the location of the passenger within the vehicle (e.g., alone or with respect to location of the driver and/or other passengers in the vehicle) can be used along with the voice recognition to determine the level of intimacy between the driver and the passenger.

In block 306, the method 300 can include determining, based at least in part on the number of passengers or the level of intimacy, a purpose associated with the driving operation. In an aspect, drive purpose identifier 112 (e.g., in conjunction with vehicle statistics system 110, sensor(s) 118, processor 120 and/or memory 122) can determine, based at least in part on the number of passengers or the level of intimacy, a purpose associated with the driving operation. For example, drive purpose identifier 112 can classify the driving operation according to one or more purposes, which may be based on the number of passengers, the level of intimacy, and/or other considerations. For example, drive purpose identifier 112 may classify a driving operation as a commute, shopping trip, pick-up or drop-off (e.g., with known or unknown passengers), leisure drive, road trip, etc. For example, the level of intimacy can also impact determination of the purpose (e.g., a higher, or closer, level of intimacy, such as a relative, may lead to a determination of a leisure trip, whereas a lower level of intimacy may lead to a determination of a car-pooling or ride-sharing trip, which may include a commute or other trip based additionally on location, time period, etc.). Thus, location, time period (e.g., time-of-day, day-of-week, day-of-month, etc.), distance, source/destination, and/or other aspects of the driving operation can be considered in classifying the driving operation. Moreover, for example, drive purpose identifier 112 can identify multiple purposes for the driving operation, such as whether the driving operations has multiple stops or is determined to have characteristics of multiple different purposes.

In one example, determining the purpose at block 306 may optionally include, at block 308, determining one or more locations corresponding to the driving operation. In an aspect, drive purpose identifier 112 (e.g., in conjunction with vehicle statistics system 110, sensor(s) 118, processor 120 and/or memory 122) can determine the one or more locations corresponding to the driving operation. For example, drive purpose identifier 112 can determine a starting location for the driving operation, an ending location for the driving operation, a stopping location for the driving operation, which may include a detected pick-up or drop-off, as described above, etc. Each location, for example, may be used in determining the purpose associated with the driving operation.

In addition, in an example, determining the purpose at block 306 may optionally include, at block 310, determining a period of time associated with the driving operation. In an aspect, drive purpose identifier 112 (e.g., in conjunction with vehicle statistics system 110, sensor(s) 118, processor 120 and/or memory 122) can determine the period of time associated with the driving operation. For example, a start time, end time, duration, time at different stops (e.g., pick-up and/or drop-off), etc., can additionally indicate a purpose for the driving operation. For example, a driving operation that starts from home and ends at an office, when made during the week around a similar time of day each weekday, can indicate a commute, and drive purpose identifier 112 can classify a driving operation as a commute based on analyzing such parameters related to the driving operation. In addition, drive purpose identifier 112 can determine whether passengers are present for all or a portion of the driving operation (e.g., whether the vehicle 102 is used in carpooling), etc., which can also be indicated in the purpose of the driving operation. In another example, a driving operation determined to include a passenger from the starting location (e.g., a house) to a stop at a school and then to an office, home, or other destination during the week can be classified, by drive purpose identifier 112, as a school drop-off (or a known passenger drop-off). Thus, drive purpose identifier 112 can determine a purpose for each driving operation of the vehicle 102 based on such parameters/considerations, and can determine the purpose at one or more specified granularities (e.g., known or unknown passenger pick-up/drop-off can indicate, respectively, carpooling versus ride sharing, or can be more specifically classified based on ending or stop location, etc.).

In some examples, determining the purpose at block 306 (and/or at blocks 308, 310) may optionally include, at block 312, determining a travel pattern corresponding to the driving operation. In an aspect, drive purpose identifier 112 (e.g., in conjunction with vehicle statistics system 110, sensor(s) 118, processor 120 and/or memory 122) can determine the travel pattern corresponding to the driving operation. In one example, this can include drive purpose identifier 112 detecting a travel pattern of multiple driving operations. For example, drive purpose identifier 112 may detect a travel pattern of driving a similar route for a number of consecutive days (e.g., 5 days) and/or at similar times during the day. This sort of travel pattern or behavior, in this example, may indicate a commute, and drive purpose identifier 112 may classify related driving operations as commutes based on detecting this pattern or other pattern associated with one or more constraints. Other patterns can be defined and/or can be detectable by the drive purpose identifier 112 for identifying a purpose of multiple driving operations based on a detected pattern, and accordingly classifying the purpose of the multiple driving operations.

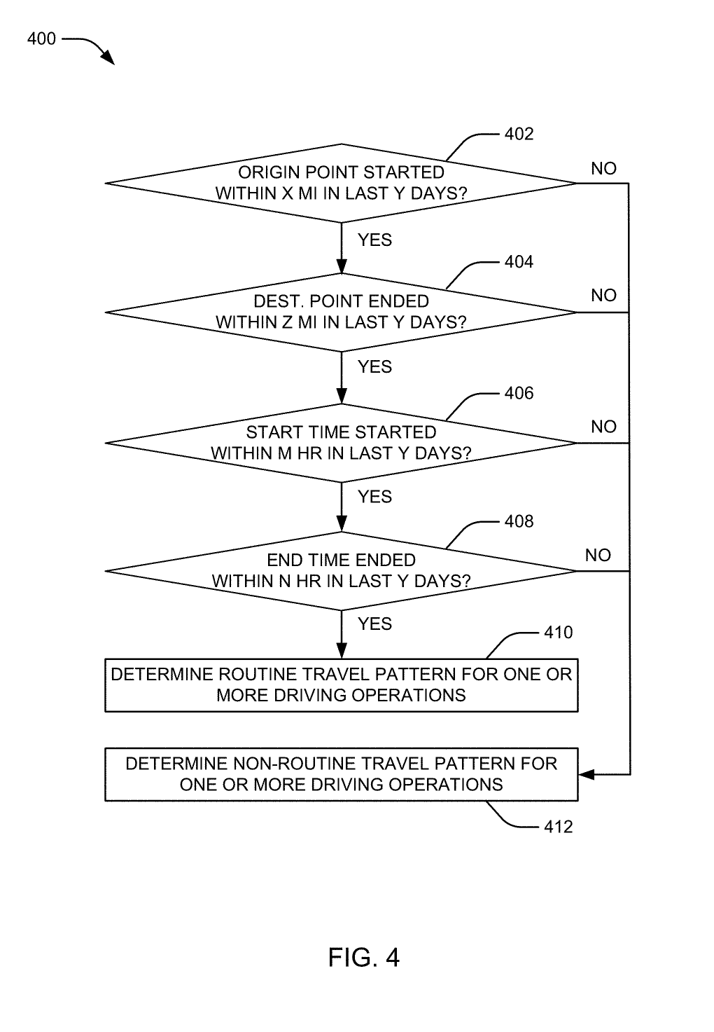

A specific example of determining travel patterns is shown in FIG. 4, which illustrates an example method 400 for determining whether a travel pattern is routine or non-routine.

In block 402, the method 400 can include determining whether an origin point of multiple driving operations started within X miles (mi) in the last Y days. In an aspect, drive purpose identifier 112 (e.g., in conjunction with vehicle statistics system 110, sensor(s) 118, processor 120 and/or memory 122) can determine whether the origin point of the multiple driving operations started within X mi (or other distance measurement) in the last Y days (or other time measurement, such as weeks, months, etc.). If so, the method 400 continues to block 404, which can include determining whether a destination point of multiple driving operations ended within Z miles (mi) in the last Y days. In an aspect, drive purpose identifier 112 (e.g., in conjunction with vehicle statistics system 110, sensor(s) 118, processor 120 and/or memory 122) can determine whether the destination point of the multiple driving operations ended within Z mi (or other distance measurement) in the last Y days (or other time measurement, such as weeks, months, etc.). For example, X and Z may be the same or different, and/or driver purpose identifier 112 may measure the destination point against drive operations for the same (Y) or different number of days as the origin point.

If the destination point ended within Z mi in the last Y days, the method 400 continues to block 406, which can include determining whether a start time of multiple driving operations started within M hours (hr) in the last Y days. In an aspect, drive purpose identifier 112 (e.g., in conjunction with vehicle statistics system 110, sensor(s) 118, processor 120 and/or memory 122) can determine whether the start time of the multiple driving operations started within M hr (or other time measurement, such as minutes, seconds, etc.) in the last Y days (or other time measurement, such as weeks, months, etc.). In an example, driver purpose identifier 112 may measure the start time against drive operations for the same (Y) or different number of days as the origin/destination point. If the start time is within M hr in the last Y days, the method 400 continues to block 408, which can include determining whether an end time of multiple driving operations ended within N hours (hr) in the last Y days. In an aspect, drive purpose identifier 112 (e.g., in conjunction with vehicle statistics system 110, sensor(s) 118, processor 120 and/or memory 122) can determine whether the end time of the multiple driving operations ended within N hr (or other time measurement, such as minutes, seconds, etc.) in the last Y days (or other time measurement, such as weeks, months, etc.). For example, M and N may be the same or different and/or driver purpose identifier 112 may measure the end time against drive operations for the same (Y) or different number of days as the start time and/or origin/destination point.

If the conditions in blocks 402, 404, 406, 408 are all positive, in this example, a routine travel pattern can be determined for one or more of the multiple driving operations at block 410. If one of the conditions in blocks 402, 404, 406, 408 is negative, in this example, a non-routine travel pattern can be determined for one or more of the multiple driving operations at block 412. This can be the determination made in Block 312 of FIG. 3, and the determination of a routine or non-routine travel pattern may impact the determination of purpose for the driving operation. For example, a routine driving operation may be determined as a commute or other pattern-detectable purpose.

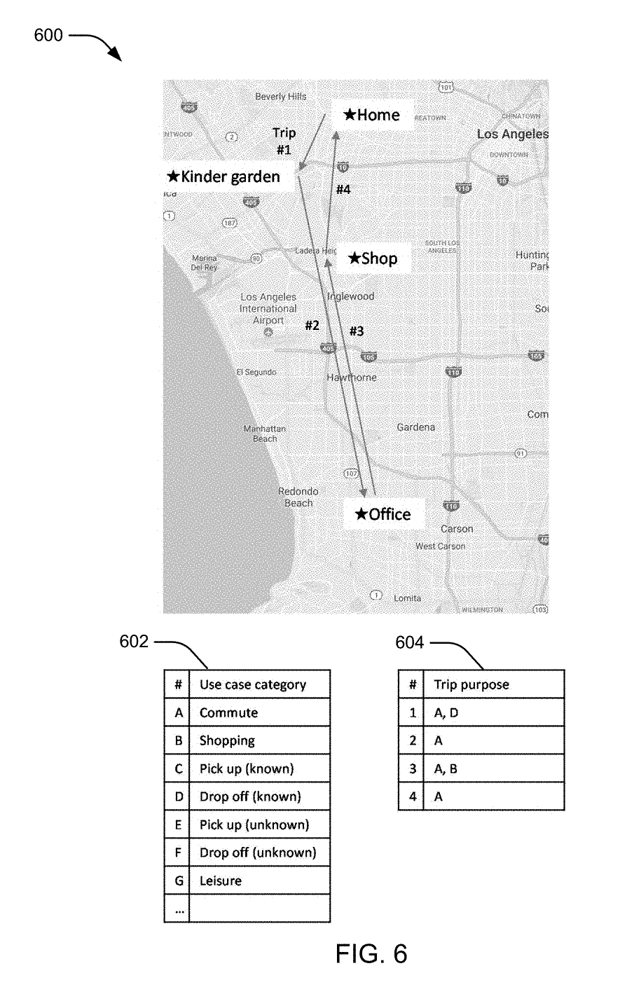

A specific example is shown in FIG. 6, which visually illustrates a daily route 600 traveled by a vehicle 102 (e.g., on a specific day) that includes multiple stops for which the driving operation may be separated into multiple driving operations or “trips.” In this example, route 600 includes four trips: (1) from home to kindergarten, (2) from kindergarten to the office, (3) from the office to shopping, and (4) from shopping to home. Each trip is classified based on one or more use case categories in table 602, such as commute, shopping, pick-up (known passenger), drop-off (known passenger), pick-up (unknown passenger), drop-off (unknown passenger), leisure, etc. Drive purpose identifier 112, for example, can determine the purpose of each trip based on one or more of the parameters described above, such as number of passengers, level of intimacy with the passengers, locations, period of time, etc. For example, drive purpose identifier 112 can classify the trips, in this example, as shown in table 604, where trip (1) is identified as commute and drop-off (known passenger), trip (2) is identified as commute, trip (3) is identified as commute and shopping, and trip (4) is identified as commute.

Referring back to FIG. 3, in block 314, the method 300 can include storing an indication of the purpose associated with the driving operation. In an aspect, drive purpose identifier 112 (e.g., in conjunction with vehicle statistics system 110, sensor(s) 118, processor 120 and/or memory 122) can store the indication of the purpose associated with the driving operation. For example, drive purpose identifier 112 can store the indication in memory 122, in a remote storage (e.g., on remote server 104) and/or otherwise by communicating the indication and/or related parameters (e.g., sensor 118 values, number of passengers, levels of intimacy, etc.) to a remote source via communications device 116, and/or the like. In one example, where drive purpose identifier 112 is at least partially implemented on the remote server 104, communications device 116 can communicate the related parameters (e.g., sensor 118 values, number of passengers, levels of intimacy, etc.) to the remote server 104 for determining the drive purpose, for determining the level of intimacy, etc. In any case, for example, statistics regarding vehicle use can be received from multiple vehicles for multiple driving operations, and stored as a survey of vehicle usage.

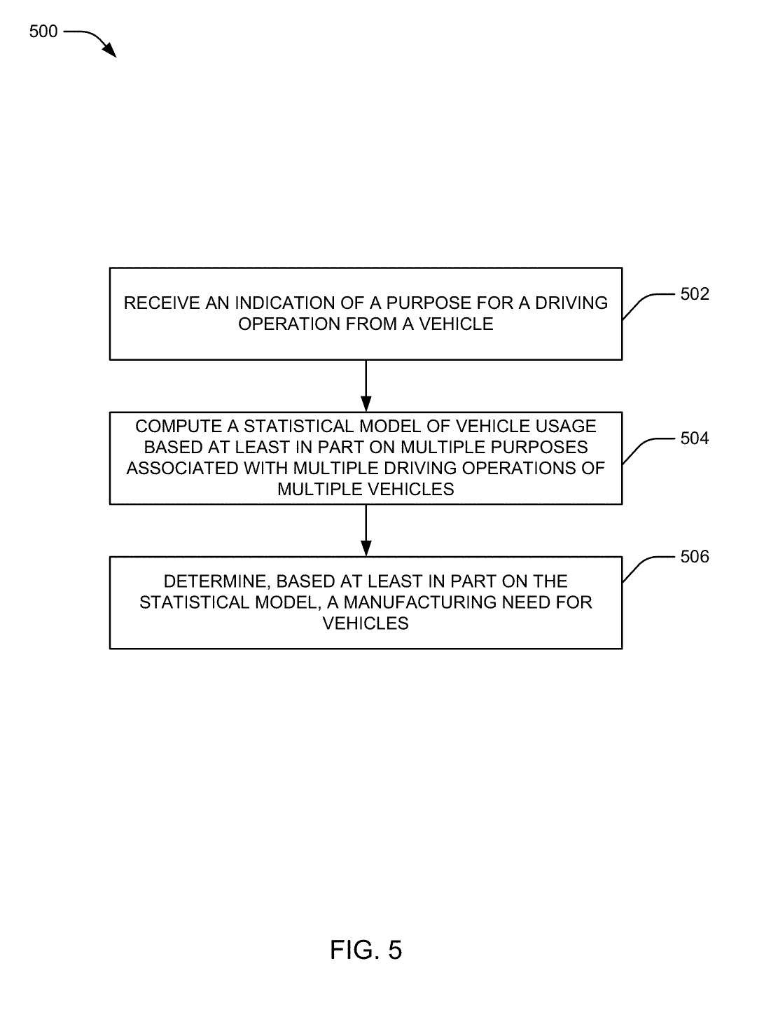

From this data, for example, vehicle usage and need considerations can be gleaned to assist in predicting or determining future need for certain vehicle types and/or vehicle options. For example, future manufacturing trends may be shifted towards manufacturing vehicles for use with specific purposes that can be used by multiple people (e.g., as part of a renting, sharing, or subscription-based program), rather than one car to fulfill all needs of a given driver. Thus, for example, drivers may have access to certain vehicle for commuting (whether as a passenger or driver), for shopping or leisure, for road trips, etc., and manufacturing can be adjusted to account for these trends. An example of using the indication of purpose for multiple driving operations from multiple vehicles is described below in reference to FIG. 5.

Referring now to FIG. 5, which is described in conjunction with the example operating environment 200 of FIG. 2, an example method 500 for determining a manufacturing need for vehicles based on receiving purposes associated with driving operations of multiple vehicles is illustrated.

In block 502, the method 500 can include receiving an indication of a purpose for a driving operation from a vehicle. In an aspect, manufacturing need predictor 212 (e.g., in conjunction with drive purpose identifier 112, processor 220 and/or memory 222) can receive the indication of the purpose for the driving operation from the vehicle. For example, manufacturing need predictor 212 may receive the indication from the vehicle (e.g., vehicle 102) and/or drive purpose identifier 112 on the remote server 104 can determine the purpose based on receiving other data from the vehicle 102, such as sensor 118 data, determined level of intimacy, determined location(s) and/or corresponding periods of time, etc., as described above. In other words, in one example, drive purpose identifier 112 may be at least partially implemented in remote server 104 and may perform one or more of the functions described of drive purpose identifier 112 with respect to FIG. 3 above.

In block 504, method 500 can include computing a statistical model of vehicle usage based at least in part on multiple purposes associated with multiple driving operations of multiple vehicles. In an aspect, manufacturing need predictor 212 (e.g., in conjunction with drive purpose identifier 112, processor 220 and/or memory 222) can compute the statistical model of vehicle usage based at least in part on multiple purposes associated with multiple driving operations of multiple vehicles. For example, manufacturing need predictor 212 can receive indications of purposes of driving operations from each of multiple vehicles 102, and the purposes may be associated with multiple drivers. In one example, the vehicle 102 can be decoupled from a single owner or family and may be used by multiple drivers. In any case, manufacturing need predictor 212 can receive the purposes identified for the vehicles, and can compute a statistical model indicating substantially any relationship between the vehicles, the type of the vehicles, the most likely uses for the vehicles, etc.

In block 506, method 500 can include determining, based at least in part on the statistical model, a manufacturing need for vehicles. In an aspect, manufacturing need predictor 212 (e.g., in conjunction with drive purpose identifier 112, processor 220 and/or memory 222) can determine, based at least in part on the statistical model, a manufacturing need for vehicles. For example, the statistical model may be analyzed over time to determine trends in vehicle usage for certain types of vehicles, certain regions where vehicles are used, etc., and manufacturing need predictor 212 can detect such trends to predict future manufacturing needs. In addition, for example, this data can be input into manufacturing analysis or production systems to affect the types, numbers, etc. of vehicles being manufactured.

In other examples, the statistical model can be used to validate target use cases for manufactured vehicles, as feedback for model planning, etc.

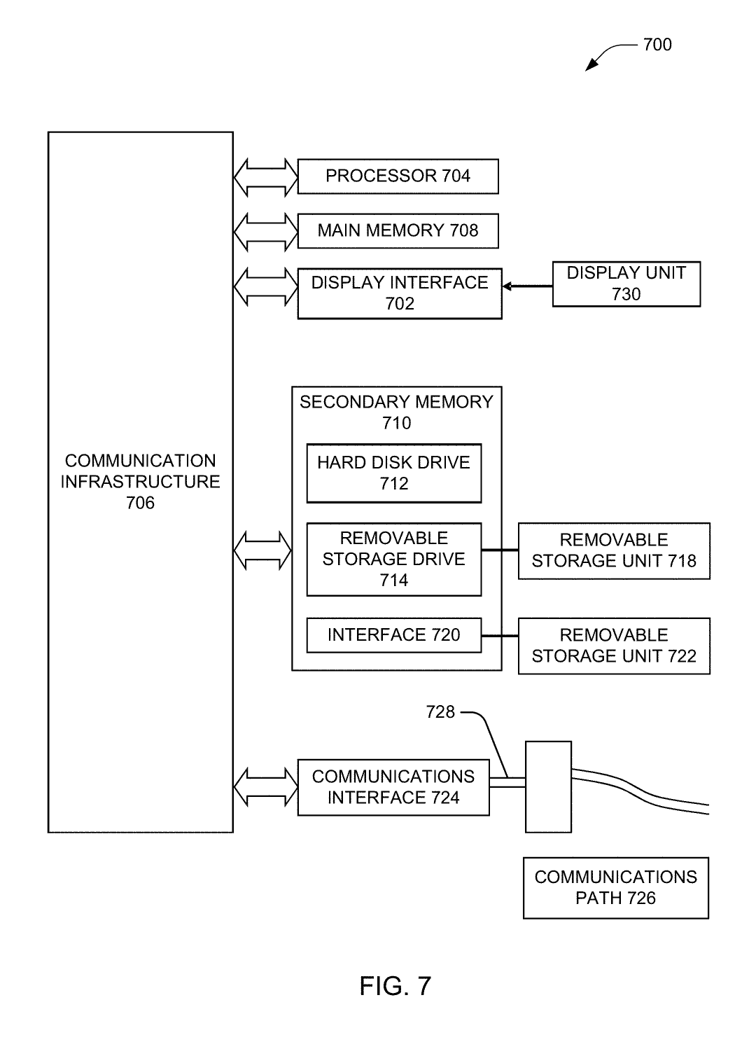

Aspects of the present disclosure can be implemented using hardware, software, or a combination thereof and can be implemented in one or more computer systems or other processing systems. In one aspect, the disclosure is directed toward one or more computer systems capable of carrying out the functionality described herein. An example of such a computer system 700 is shown in FIG. 7.

FIG. 7 presents an example system diagram of various hardware components and other features, for use in accordance with an aspect of the present disclosure. Aspects of the present disclosure can be implemented using hardware, software, or a combination thereof and can be implemented in one or more computer systems or other processing systems. In one example variation, aspects described herein can be directed toward one or more computer systems capable of carrying out the functionality described herein. An example of such a computer system 700 is shown in FIG. 7.

Computer system 700 includes one or more processors, such as processor 704. The processor 704 is connected to a communication infrastructure 706 (e.g., a communications bus, cross-over bar, or network). In one example, processor 120, 202 can include processor 704. Various software aspects are described in terms of this example computer system. After reading this description, it will become apparent to a person skilled in the relevant art(s) how to implement aspects described herein using other computer systems and/or architectures.

Computer system 700 can include a display interface 702 that forwards graphics, text, and other data from the communication infrastructure 706 (or from a frame buffer not shown) for display on a display unit 730. Interface 210 can include display interface 702, in one example. Computer system 700 also includes a main memory 708, preferably random access memory (RAM), and can also include a secondary memory 710. The secondary memory 710 can include, for example, a hard disk drive 712 and/or a removable storage drive 714, representing a floppy disk drive, a magnetic tape drive, an optical disk drive, etc. The removable storage drive 714 reads from and/or writes to a removable storage unit 718 in a well-known manner. Removable storage unit 718, represents a floppy disk, magnetic tape, optical disk, etc., which is read by and written to removable storage drive 714. As will be appreciated, the removable storage unit 718 includes a computer usable storage medium having stored therein computer software and/or data.

In alternative aspects, secondary memory 710 can include other similar devices for allowing computer programs or other instructions to be loaded into computer system 700. Such devices can include, for example, a removable storage unit 722 and an interface 720. Examples of such can include a program cartridge and cartridge interface (such as that found in video game devices), a removable memory chip (such as an erasable programmable read only memory (EPROM), or programmable read only memory (PROM)) and associated socket, and other removable storage units 722 and interfaces 720, which allow software and data to be transferred from the removable storage unit 722 to computer system 700. In an example, memory 122, 204 can include one or more of main memory 708, secondary memory 710, removable storage drive 714, removable storage unit 718, removable storage unit 722, etc.

Computer system 700 can also include a communications interface 724. Communications interface 724 allows software and data to be transferred between computer system 700 and external devices. Examples of communications interface 724 can include a modem, a network interface (such as an Ethernet card), a communications port, a Personal Computer Memory Card International Association (PCMCIA) slot and card, etc. Software and data transferred via communications interface 724 are in the form of signals 728, which can be electronic, electromagnetic, optical or other signals capable of being received by communications interface 724. These signals 728 are provided to communications interface 724 via a communications path (e.g., channel) 726. This path 726 carries signals 728 and can be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 780, a hard disk installed in hard disk drive 770, and signals 728. These computer program products provide software to the computer system 700. Aspects described herein can be directed to such computer program products. Communications device 116, 206 can include communications interface 724.

Computer programs (also referred to as computer control logic) are stored in main memory 708 and/or secondary memory 710. Computer programs can also be received via communications interface 724. Such computer programs, when executed, enable the computer system 700 to perform various features in accordance with aspects described herein. In particular, the computer programs, when executed, enable the processor 704 to perform such features. Accordingly, such computer programs represent controllers of the computer system 700. Computer programs can include application 207.

In variations where aspects described herein are implemented using software, the software can be stored in a computer program product and loaded into computer system 700 using removable storage drive 714, hard disk drive 712, or communications interface 720. The control logic (software), when executed by the processor 704, causes the processor 704 to perform the functions in accordance with aspects described herein as described herein. In another variation, aspects are implemented primarily in hardware using, for example, hardware components, such as application specific integrated circuits (ASICs). Implementation of the hardware state machine so as to perform the functions described herein will be apparent to persons skilled in the relevant art(s).

In yet another example variation, aspects described herein are implemented using a combination of both hardware and software.

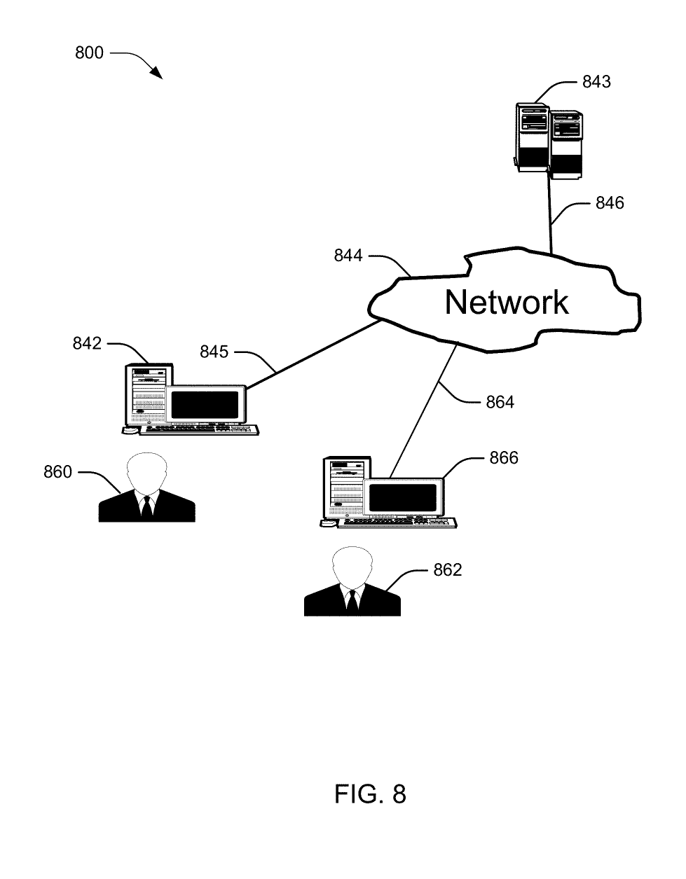

FIG. 8 is a block diagram of various example system components, in accordance with an aspect. FIG. 8 shows a communication system 800 usable in accordance with aspects described herein. The communication system 800 includes one or more accessors 860, 862 (also referred to interchangeably herein as one or more “users”) and one or more terminals 842, 866. For example, terminals 842, 866 can include vehicle 102 or a related system (e.g., vehicle statistics system 110, processor 120, communications device 116, etc.), remote server 104 (processor 202, communications device 206, etc.), and/or the like. In one aspect, data for use in accordance with aspects described herein is, for example, input and/or accessed by accessors 860, 862 via terminals 842, 866, such as personal computers (PCs), minicomputers, mainframe computers, microcomputers, telephonic devices, or wireless devices, such as personal digital assistants (“PDAs”) or a hand-held wireless devices coupled to a server 843, such as a PC, minicomputer, mainframe computer, microcomputer, or other device having a processor and a repository for data and/or connection to a repository for data, via, for example, a network 844, such as the Internet or an intranet, and couplings 845, 846, 864. The couplings 845, 846, 864 include, for example, wired, wireless, or fiberoptic links. In another example variation, the method and system in accordance with aspects described herein operate in a stand-alone environment, such as on a single terminal.

The aspects discussed herein can also be described and implemented in the context of computer-readable storage medium storing computer-executable instructions. Computer-readable storage media includes computer storage media and communication media. For example, flash memory drives, digital versatile discs (DVDs), compact discs (CDs), floppy disks, and tape cassettes. Computer-readable storage media can include volatile and nonvolatile, removable and non-removable media implemented in any method or technology for storage of information such as computer readable instructions, data structures, modules or other data.

It will be appreciated that various implementations of the above-disclosed and other features and functions, or alternatives or varieties thereof, can be desirably combined into many other different systems or applications. Also that various presently unforeseen or unanticipated alternatives, modifications, variations, or improvements therein can be subsequently made by those skilled in the art which are also intended to be encompassed by the following claims.

What is claimed is:

1. A method for determining vehicle use statistics, comprising:
determining, during and after a driving operation of a vehicle and based at least in part on one or more sensors in the vehicle, a number of passengers in the vehicle;
determining, based at least in part on the one or more sensors in the vehicle and where the number of passengers in the vehicle is at least one, a level of intimacy between a driver of the vehicle and at least one of the number of passengers in the vehicle;
determining, based at least in part on the number of passengers in the vehicle or the level of intimacy, a purpose associated with the driving operation; and
storing an indication of the purpose associated with the driving operation.

2. The method of claim 1, further comprising determining a future manufacturing need for vehicles based at least in part on analyzing the purpose associated with the driving operation along with multiple purposes related to multiple other driving operations and travel patterns.

3. The method of claim 2, wherein determining the future manufacturing need is further based at least in part on the number of passengers during and after the driving operation.

4. The method of claim 1, wherein determining the purpose associated with the driving operation is further based at least in part on one or more locations at which the vehicle is stopped during and after the driving operation.

5. The method of claim 1, wherein determining the purpose associated with the driving operation is further based at least in part on one or more periods of time associated with the driving operation.

6. The method of claim 1, wherein determining the number of passengers is based at least in part on information from one or more seat sensors in the vehicle.

7. The method of claim 1, wherein determining the level of intimacy is based at least in part on detecting a seat occupied by the at least one of the number of passengers in the vehicle.

8. The method of claim 1, wherein determining the level of intimacy is based at least in part on voice recognition performed within the vehicle.

9. A vehicle comprising:
a vehicle statistics system, comprising:
one or more sensors for detecting presence of one or more passengers in the vehicle;
a memory; and
at least one processor coupled to the memory and configured to:
determine, during and after a driving operation of the vehicle and based at least in part on the one or more sensors in the vehicle, a number of passengers in the vehicle;
determine, based at least in part on the one or more sensors in the vehicle and where the number of passengers in the vehicle is at least one, a level of intimacy between a driver of the vehicle and at least one of the number of passengers in the vehicle;
determine, based at least in part on the number of passengers in the vehicle or the level of intimacy, a purpose associated with the driving operation; and
store an indication of the purpose associated with the driving operation.

10. The vehicle of claim 9, further comprising a communications device for communicating the indication to a remote server configured for determining a future manufacturing need for vehicles based at least in part on analyzing the purpose associated with the driving operation along with multiple purposes related to multiple other driving operations and travel patterns.

11. The vehicle of claim 9, wherein the at least one processor is configured to determine the purpose associated with the driving operation further based at least in part on one or more locations at which the vehicle is stopped during and after the driving operation.

12. The vehicle of claim 9, wherein the at least one processor is configured to determine the purpose associated with the driving operation further based at least in part on one or more periods of time associated with the driving operation.

13. The vehicle of claim 9, wherein the one or more sensors comprise one or more seat sensors, and the at least one processor is configured to determine the number of passengers based at least in part on information from the one or more seat sensors in the vehicle.

14. The vehicle of claim 9, wherein the at least one processor is configured to determine the level of intimacy based at least in part on detecting a seat occupied by the at least one of the number of passengers in the vehicle.

15. The vehicle of claim 9, wherein the at least one processor is configured to determine the level of intimacy is based at least in part on voice recognition performed within the vehicle.

16. A non-transitory computer-readable medium storing computer executable code for determining vehicle use statistics, comprising code for:
determining, during and after a driving operation of a vehicle and based at least in part on one or more sensors in the vehicle, a number of passengers in the vehicle;
determining, based at least in part on the one or more sensors in the vehicle and where the number of passengers in the vehicle is at least one, a level of intimacy between a driver of the vehicle and at least one of the number of passengers in the vehicle;
determining, based at least in part on the number of passengers in the vehicle or the level of intimacy, a purpose associated with the driving operation; and
storing an indication of the purpose associated with the driving operation.

17. The non-transitory computer-readable medium of claim 16, further comprising code for determining a future manufacturing need for vehicles based at least in part on analyzing the purpose associated with the driving operation along with multiple purposes related to multiple other driving operations and travel patterns.

18. The non-transitory computer-readable medium of claim 16, wherein the code for determining the purpose associated with the driving operation determines based at least in part on one or more locations at which the vehicle is stopped during and after the driving operation.

19. The non-transitory computer-readable medium of claim 16, wherein the code for determining the purpose associated with the driving operation determines based at least in part on one or more periods of time associated with the driving operation.

20. The non-transitory computer-readable medium of claim 16, wherein the code for determining the number of passengers determines based at least in part on information from one or more seat sensors in the vehicle.
